(19) United States
(12) Patent Application Publication
(10) Pub. No.: US 2026/0108933 A1
(43) Pub. Date: Apr. 23, 2026

(54) ADDITIVELY PRODUCED COATED FOUNDRY TOOLING

(71) Applicant: Mueller International, LLC, Atlanta, GA (US)

(72) Inventor: Jason White Bradley, Soddy-Daisy, TN (US)

(21) Appl. No.: 18/918,474

(22) Filed: Oct. 17, 2024

(51) Int. Cl. B22C 7/06; B33Y 40/20; B33Y 80/00

(52) U.S. Cl. CPC B22C 7/06; B33Y 40/20; B33Y 80/00

(57) ABSTRACT

A foundry tooling body includes portions or features formed in accordance with a predetermined model that are at least partially coated using one of PVD coating and electroplating to form a metallic surface of at least a portion of the foundry tooling body, wherein each metallic surface is configured to produce a sand mold suitable for casting parts.

### TECHNICAL FIELD

This disclosure relates to foundry tooling. More specifically, this disclosure relates to foundry tooling produced using advanced methods.

### BACKGROUND

“Foundry tooling,” in the context of the present disclosure, can means an object that is used to manufacture a mold that is used to create a casting or cast part, where the object can be a pattern (used to make a mold that forms the outside of a casting), a core box (used to make cores that are used in a mold to form an inside portion, void, or hollow area of a casting), or a cope and drag of a pattern. Manufacturing methods can use three-dimensional printing (also called additive manufacturing (AM) or additively produced) techniques such as fused deposition modeling (FDM), digital light projection (DLP), or stereolithography (SLA). However, the use of AM techniques to manufacture foundry tooling has realized limited adoption when compared to other manufacturing techniques. The primary limitations that have prevented this transition can include premature wear compared to traditional tool steel, layer line (striation) issues that can pose dimensional or mold quality issues, and physical and/or chemical issues related to such parameters as heat resistance, UV vulnerabilities, and mechanical properties. Those limitations can prevent this industry from realizing the tremendous time savings and cost savings potential of AM techniques, and can be understood to be responsible for relegating AM to not much more than a prototyping tool as a precursor to constructing foundry tooling using traditional materials.

### SUMMARY

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

Disclosed is a method of manufacturing foundry tooling that can include the steps of forming a foundry tooling body in accordance with a predetermined model; and coating the foundry tooling body using PVD to add a metallic coating to at least a portion of the foundry tooling body to define at least one coated tooling body surface, wherein each coated tooling body surface can be configured to contact a malleable blank to produce a sand mold suitable for manufacturing a casting.

Also disclosed is a method of manufacturing a casting that can include the steps of manufacturing a foundry tooling body, and the step of manufacturing the foundry tooling body can include the steps of: forming a foundry tooling body in accordance with a predetermined model and coating the foundry tooling body using PVD to add a metallic coating to at least a portion of the foundry tooling body to define at least one coated tooling body surface, wherein each coated tooling body surface can be configured to contact a malleable blank to produce a sand mold suitable for manufacturing a casting, wherein the foundry tooling body can define a first configuration; loading the foundry tooling body into a molding machine; using the molding machine to bring the foundry tooling body into contact with a malleable blank including a mixture of sand and a resin; and using the molding machine to further urge the foundry tooling body toward the malleable blank such that the foundry tooling can exert pressure upon the malleable blank until the malleable blank transforms into a sand mold, and the sand mold can define a second configuration complementary to the first configuration, wherein the second configuration can define at least one sand mold cavity.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale. Corresponding features and components throughout the figures may be designated by matching reference characters for the sake of consistency and clarity.

FIG. 1 is a perspective view illustrating a step in the three-dimensional printing of a foundry tooling body constructed in accordance with aspects of the present disclosure.

FIG. 2 is a perspective view illustrating a cleaning step concerning the foundry tooling body printed in FIG. 1.

FIG. 3A is a perspective view of a pair of foundry tooling bodies undergoing an electroplating step in accordance with some methods of the present disclosure.

FIG. 3B is a perspective view of a pair of foundry tooling bodies undergoing a PVD coating step in accordance with some methods of the present disclosure.

FIG. 4 is a perspective view, partially in section, of a completed and coated foundry tooling produced in accordance with some methods of the present disclosure.

FIG. 5 is an enlarged detail view of a portion of the completed and coated foundry tooling encircled in FIG. 4.

FIG. 6 is a top perspective view of the foundry tooling illustrated in FIG. 4.

FIG. 7 is a perspective view of the coated foundry tooling of FIG. 6 loaded into a molding machine.

FIG. 8 is a top perspective view of a sand mold produced by the foundry tooling of FIG. 6 and the molding machine of FIG. 7.

FIG. 9 is a flow chart for method steps to be performed in accordance with some aspects of the present disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference numerals common to more than one accompanying figure identify the same component throughout the figures.

As used throughout, the singular forms “a,” “an” and “the” include plural referents unless the context clearly dictates otherwise. Thus, for example, reference to a quantity of one of a particular element can comprise two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or substantially,” it will be understood that the particular value forms another aspect. It will be further understood that the endpoints of each of the ranges are significant both in relation to the other endpoint, and independently of the other endpoint.

For purposes of the present disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

To simplify the description of various elements disclosed herein, the conventions of “top,” “bottom,” “side,” “upper,” “lower,” “horizontal,” and/or “vertical” may be referenced. Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

As stated above, the term “foundry tooling” can encompass patterns, core boxes, and copes and drags of patterns. Examples of core boxes, including cold boxes, which are core boxes that are not heated during the process of making cores with the cold box, are taught in U.S. Pat. No. 11,458,532, which issued Oct. 4, 2022, the disclosure of which is hereby incorporated by reference herein in its entirety. In a method executed in accordance with aspects of the present disclosure, a body of a foundry tooling (also called a base model or a core box), can be formed by any suitable additive manufacturing (hereinafter “AM”) technique, and the formed body of the foundry tooling can undergo a coating step. In various aspects, the coating step can be an electroplating step. In various aspects, the coating step can be a physical vapor deposition (hereinafter “PVD”) step. Examples of AM processes can be understood with reference to U.S. Pat. No. 10,558,198, which issued on Feb. 11, 2020, the disclosure of which is hereby incorporated by reference herein in its entirety. Electroplating can provide the formed body with a metallic (such as nickel) coating. PVD coating can provide the formed body with a metallic coating of various materials, including titanium, zirconium, aluminum, chromium nitride, titanium nitride, zirconium nitride, aluminum titanium nitride, steel, copper, and gold, among others. Advantageously, the method can produce a hardened metallic finish that can provide additional wear resistance and toughness, UV protection, heat resistance, humidity protection, and cleaner separation between the negative and a mold produced with the negative during a mold forming process. The method also can substantially shorten tooling development cycles from being measured in months to being measured in days for many types of foundry tooling. Discussion of additive manufacturing and electroplating can be found with reference to the application for U.S. Patent bearing application Ser. No. 18/782,657, filed on Jul. 24, 2024, which is hereby incorporated by reference herein in tis entirety.

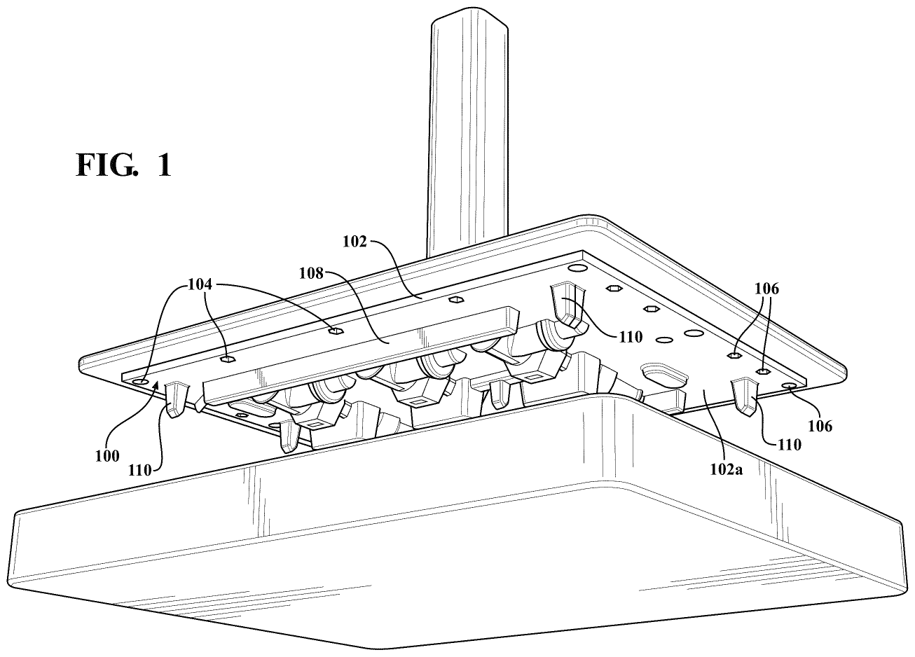

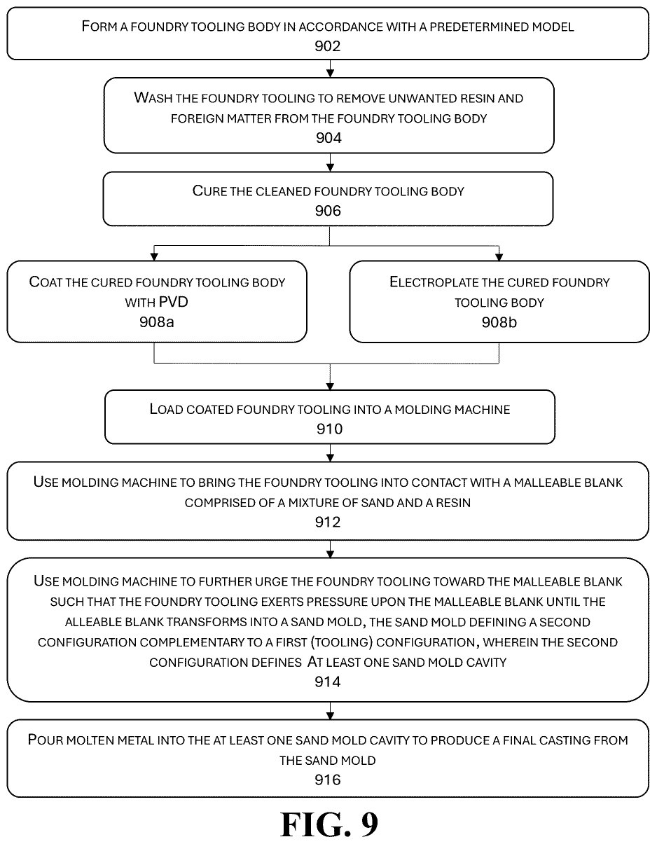

FIG. 1 is a perspective view illustrating an example of step 902 in the method of FIG. 9, namely, a step in the three-dimensional printing of a foundry tooling body 100 constructed in accordance with some aspects of the present disclosure. The foundry tooling body 100 can be shown for exemplary purposes in FIG. 1 and in subsequent figures herein as a pattern body, but it can be understood that the foundry tooling body 100 can take the form of either a pattern body or a core box body. The material comprising the formed foundry tooling body 100 can comprise a polymer containing carbon fibers defining a carbon-fill percentage of approximately 20%, produced by the three-dimensional printing method disclosed in U.S. Pat. Nos. 11,458,532 and/or 10,558,198, each of which is incorporated by reference in its entirety as stated above. The material comprising the foundry tooling body 100 can comprise photocured resin. In various aspects, the foundry tooling body 100 can be formed of photocured resin. Other AM techniques are also contemplated as being within the scope of the present disclosure in terms of how the foundry tooling body 100 can be formed, and in terms of what material can comprise the foundry tooling body 100. The composition of the foundry tooling body 100 can vary depending upon which AM process is used. For example, the composition of foundry tooling body 100 can be any material suitable for digital light processing (hereinafter “DLP”), suitable for stereolithography (hereinafter “SLA”), or suitable for fused deposition modeling (hereinafter “FDM”), among other AM methods. In any of the AM techniques, the foundry tooling body 100 can be formed in accordance with a predetermined model that can be expressed as machine-readable instructions executed by computing system operatively connected to the AM hardware employed to form the foundry tooling body 100. In other aspects of the present disclosure, the foundry tooling body 100 can be formed through implementing a technique other than AM, in which case the foundry tooling body 100 can be composed of a more traditional material, such as metal, and in which case the foundry tooling can comprise a cope and drag of a pattern.

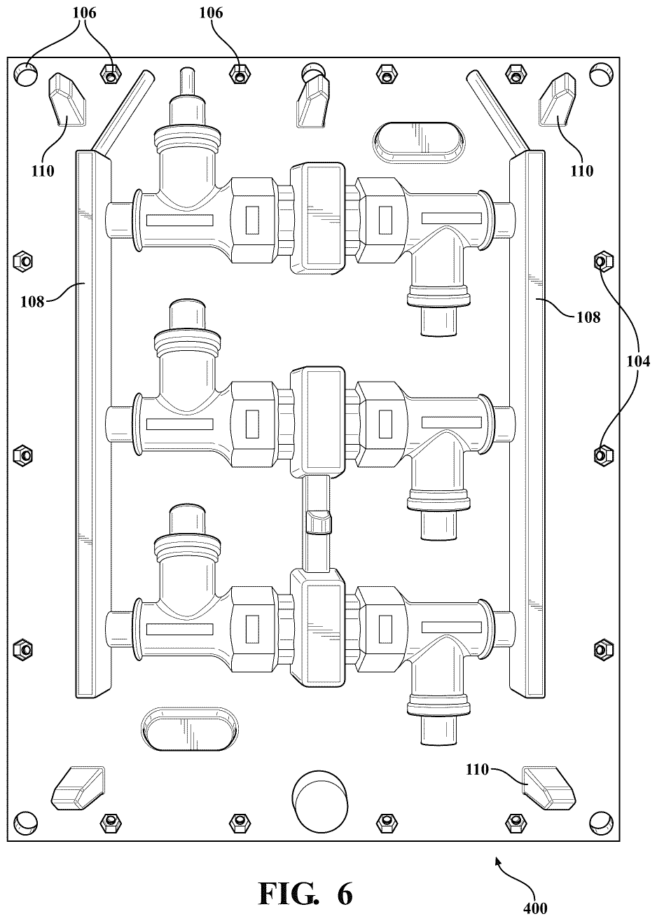

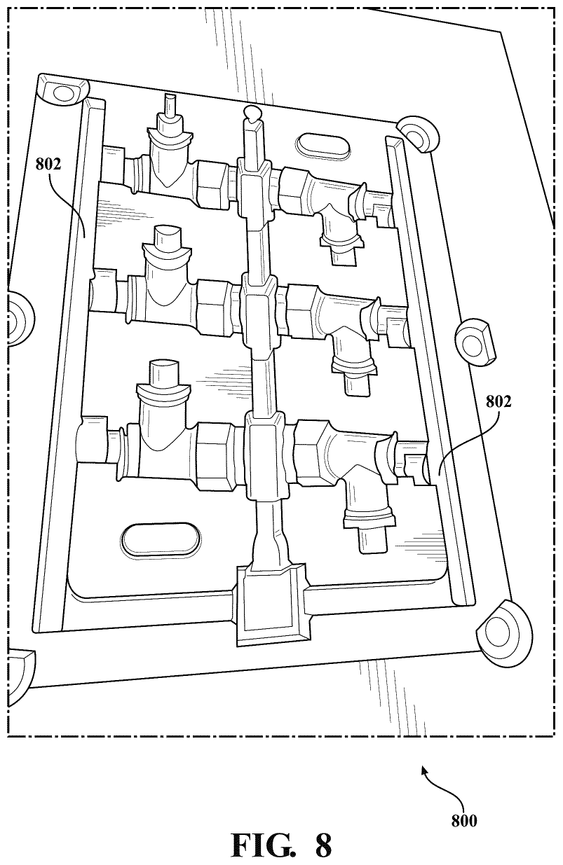

In the example of FIG. 1, the foundry tooling body 100 can be configured to produce a sand mold that can function as a negative of a final casting or cast part to be produced, as will be further discussed herein with reference to FIG. 8. In the example of FIG. 1, the foundry tooling body 100 can define a plate 102 defining an outer surface 102a, a plurality of longitudinally arranged apertures 104 extending through the surface 102a, and a plurality of laterally arranged apertures 106 also extending through the surface 102a. One or more ribs 108 and a plurality of lugs 110 can extend outwardly (substantially downwardly in the orientation shown in FIG. 1) from the surface 102a. The configuration of the foundry tooling body 100 depicted in FIG. 1 can be merely exemplary and can assume any configuration depending on the configuration desired for the mold ultimately produced with a completed (coated) foundry tooling 400 (FIG. 6).

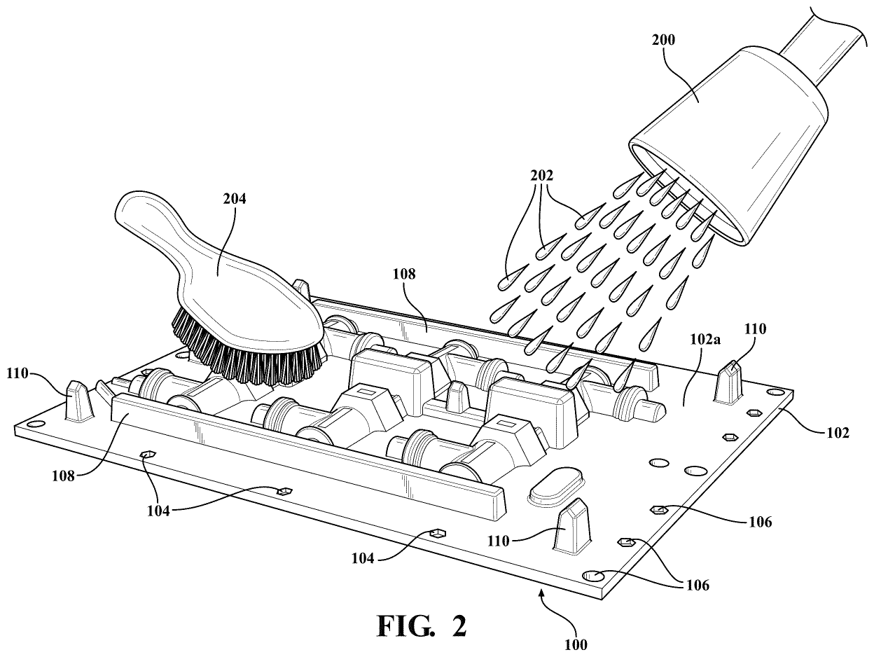

FIG. 2 is a perspective view illustrating an example of step 904 in the method of FIG. 9, namely, a cleaning step concerning the foundry tooling body 100, which can be placed in proximity to a fluid head 200. A liquid detergent 202, such as isopropyl alcohol or a commercially available agent, can exit the fluid head 200 under pressure to impinge exposed surfaces of the foundry tooling body 100. A brush 204 can be used to loosen and remove any foreign matter—including any resin remaining from the forming step discussed above with regard to FIG. 1—from the surface of the foundry tooling body 100.

After the cleaning step of in FIG. 2 is completed, the foundry tooling body 100 can be cured (FIG. 9, step 906). The curing process can vary with the type of unit that performs the AM process exemplified in FIG. 1. One example of a curing method for a part formed by SLA can be irradiation of the formed part with ultraviolet (UV) light. Such curing can be performed by various products such as the PostCure™ 1050 post-processing system sold by 3D Systems, Inc., the system capable of irradiating a formed part with UV light from multiple UV light modules. Such a system can also optionally dry the part to remove excess solvent prior to curing.

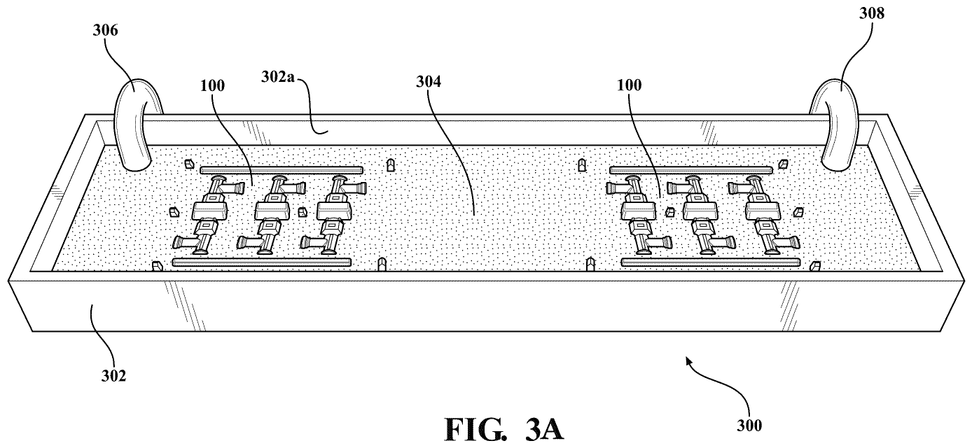

FIG. 3A is a perspective view of a pair of foundry tooling bodies 100 that can be undergoing the coating step—and, more specifically, an electroplating step (FIG. 9, step 908a) at an electroplating station 300, in accordance with some methods of the present disclosure. Each of the foundry tooling bodies 100 can be shown configured as discussed above with regard to FIG. 1. Although FIG. 3A can show two foundry tooling bodies 100 simultaneously undergoing the electroplating step 908a, a lesser or greater number of foundry tooling bodies 100 can undergo this step at the electroplating station 300. As shown with reference to FIG. 3A, the electroplating station 300 can comprise a pan 302 defining a chamber 302a configured to hold a quantity of electroplating fluid 304 sufficient to cover the foundry tooling bodies 100 completely if necessary for at least a portion of the electroplating process. The electroplating station 300 can further comprise a power supply (not shown) electrically connected to the pan 302 such that electrical current can cause the electroplating fluid 304 to ionize when the power supply is activated, thereby causing metallic ions to precipitate on the submerged surfaces of the foundry tooling bodies 100. The electroplating station 300 can further comprise a pair of electroplating fluid supply tubes 306,308, through which the electroplating fluid 304 can be admitted into or evacuated from the pan 302 responsive to action of one or more pumps (not shown) operatively communicating with the supply tubes 306,308.

FIG. 3B is a perspective view of the pair of foundry tooling bodies 1000 that can be undergoing the coating step-and, more specifically, a PVD coating step (FIG. 9, step 908b). In various aspects of the current disclosure, PVD can be utilized in place of electroplating. PVD can also be physical vapor transport (hereinafter “PVT”) in various aspects. One of skill in the art would understand that PVD and PVT can be interchanged without departing from any scope of the current disclosure.

PVD can provide some advantages over electroplating in the context of foundry tooling in various aspects. In various aspects, PVD can be utilized in applications where electroplating might not be available or easily applicable.

In various aspects, PVD coating can be of a smaller thickness of coating than electroplating. In various aspects, PVD coating can be about 0.001 inches in application thickness, as compared to electroplating, which can be about 0.006 inches in application thickness. Although thinner in application thickness, PVD can maintain durability similar to or greater than electroplating. PVD can be utilized for abrasion resistance and for imparting hardness to a surface of any part to which it is applied. Because PVD can be as thin as 0.001 inches in application thickness, PVD can be utilized to coat surface details and small features effectively without substantially modifying the shape of the part to which it is applied. In various aspects, PVD coating can be between 0.001 inches and 0.004 inches in thickness. In various aspects, PVD coating can be between 0.001 inches and 0.002 inches in thickness.

Even for relatively weak materials such as SLA, PVD application can provide a hardened surface that can resist degradation over time. For applications of porous AM such as FDM, PVD coating can be utilized in ways that electroplating generally cannot. Electroplating in various aspects can require electron charging as part of the electroplating process. For various materials—including FDM—electroplating can be inappropriate because electrons do not easily charge within certain materials. For such materials, PVD can be utilized to provide a coating when electroplating is generally unavailable.

The PVD coating step 908b can accomplished by applying PVD using any of a known number of methods or combinations thereof. PVD can be applied by use of any of the following methods: cathodic arc deposition, electron-beam physical vapor deposition, evaporative deposition, close-space sublimation, pulsed laser deposition, thermal laser epitaxy, sputter deposition, pulsed electron deposition, and sublimation sandwich deposition, among others. One of skill in the art would understand that varying methods of PVD application can be utilized without departing from the scope of the current disclosure.

As seen in FIG. 3B, a vacuum coating subsystem 351 of a PVD coating system 350 can be utilized to coat the foundry tooling bodies 100 with PVD. The vacuum coating subsystem 351 can define a vacuum chamber 352 within which the foundry tooling bodies 100 can be arranged. The PVD coating system 350 can be a VT-1500i PVD coating system supplied by Vapor Technologies, Inc., 6400 Dry Creek Pkwy, Longmont, Colorado 80503. Various other PVD coating systems can be utilized without departing from the scope of the current disclosure. The vacuum chamber 352 can be a “coating chamber” in various aspects. In various aspects, the foundry tooling bodies 100 can be arranged on a rack 361. In various aspects, the foundry tooling bodies 100 can be hung from a line within the vacuum chamber 352. In various aspects, the vacuum chamber 352 can comprise a turntable 362 to turn the foundry tooling bodies 100 during application of PVD to allow uniform coating of PVD.

Following loading of the foundry tooling bodies 100 within the vacuum chamber 352, a vacuum chamber door 353 can be closed and secured to enclose the foundry tooling bodies 100 within the vacuum chamber 352. A vacuum pumping system 354 can be actuated to remove ambient air from the vacuum coating subsystem 351. Once air is removed from the vacuum chamber 352, an operator can engage the PVD coating system 350 to perform PVD coating of the foundry tooling bodies 100. In one aspect, the foundry tooling bodies 100 can be coated via a cathodic arc deposition system, in which a copper coil wrapped around a metallic source material can arc the source material to vaporize the source material through ionization and evaporation. The ionized, evaporated source material can then be adhered to the foundry tooling bodies 100. Following completion of the PVD coating, the vacuum chamber door 353 can be opened, and the PVD coated foundry tooling bodies 100 can be removed from the vacuum chamber 352.

In various aspects, the turntable can be utilized to coat foundry tooling bodies 100 on all sides. In various aspects, the foundry tooling bodies 100 can be PVD coated on one side only. One of skill in the art would understand that various applications can require PVD coating of various surfaces.

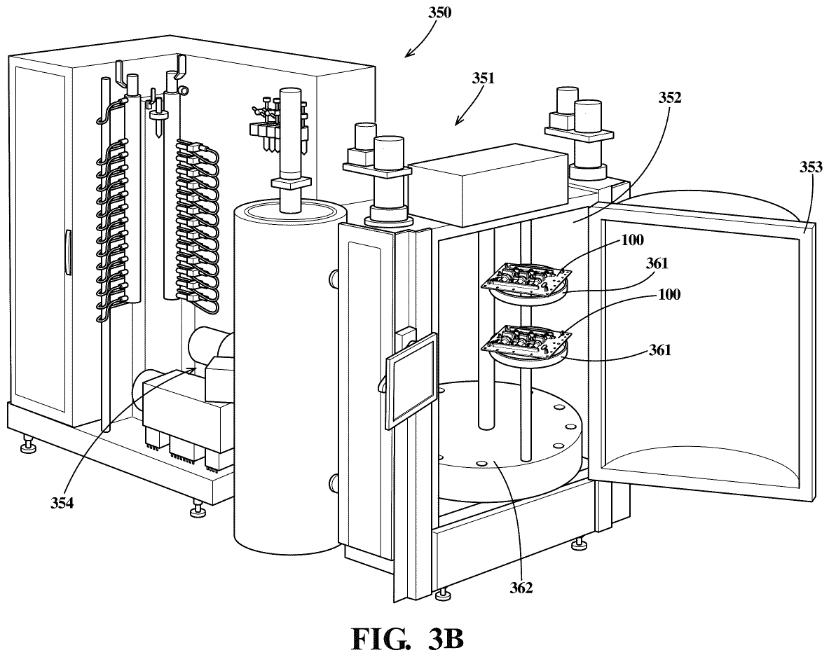

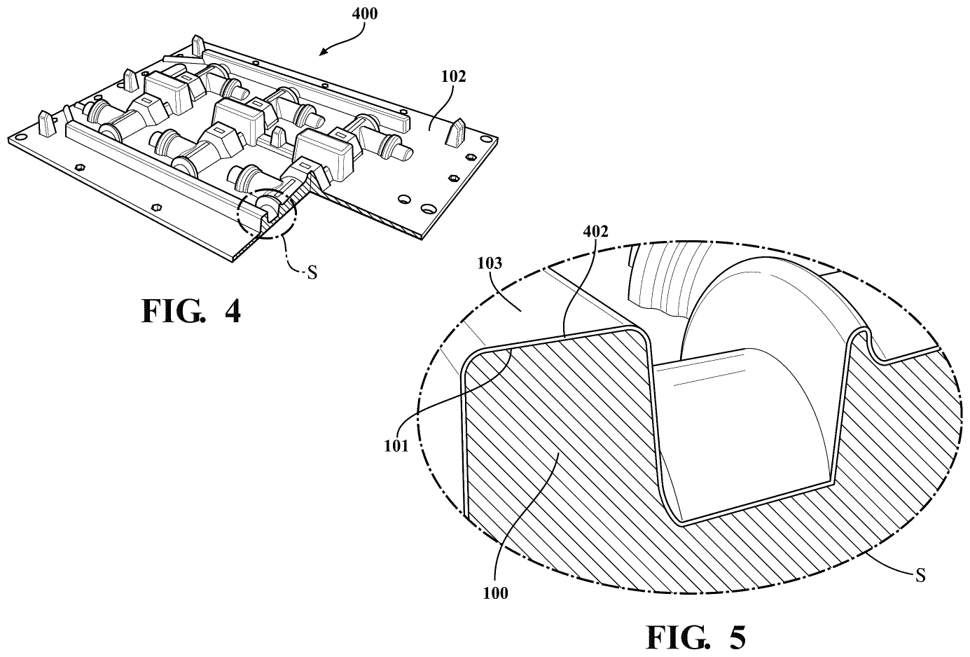

FIGS. 4 and 5 illustrate a completed and coated foundry tooling 400 produced in accordance with some methods of the present disclosure. FIG. 4 can illustrate the coated foundry tooling 400 in a perspective view and partially in section with respect to a portion of the plate 102 being cut away for illustrative purposes. The sectional view can include an encircled section S, which is enlarged in the detail view of FIG. 5. The foundry tooling 400 can be configured identically to the foundry tooling body 100 discussed with regard to FIGS. 1-3, above, except that that the foundry tooling 400 can include a metallic coating 402 covering the foundry tooling body 100. In various aspects, the metallic coating 402 need not encapsulate the foundry tooling body 100 in its entirety, as shown in FIG. 5. Instead, in various aspects, the metallic coating 402 can be applied only on tooling body surfaces (such as tooling body surface 101 in FIG. 5) that can define coated tooling body surfaces, wherein each coated tooling body surface (such as tooling body surface 103 in FIG. 5) can be configured to contact a malleable blank to produce a sand mold (such as sand mold 800 in FIG. 8) suitable for manufacturing a casting. The metallic coating 402 can be produced by the electroplating process discussed above with reference to FIG. 3A or by the PVD coating processed discussed above with reference to FIG. 3B. In various aspects, the metallic coating 402 can be composed of nickel. However, nickel can be just one example of the materials of which the metallic coating can be composed, and any commonly used plating material can be used to compose the metallic coating 402. For further example—and with specific reference to electroplating—the metallic coating 402 can be composed of a combination of nickel and copper, where copper can be a base coat and nickel can be a top coat. The resulting plating can have a thickness that can fall within the range from (and including) 0.006 inches to (and including) 0.008 inches in various aspects. For further example—and with specific reference to PVD coating—the coating can be chromium nitride and can be of a thickness that can fall with thin the range from (and including) 0.001 inches to (and including) 0.002 inches. As stated above, the metallic coating 402 can provide additional wear resistance and toughness, UV protection, heat resistance, humidity protection, and cleaner separation between the completed foundry tooling 400 and a sand mold 800 (FIG. 8) produced with the foundry tooling 400 in the manner discussed herein with regard to FIG. 8.

FIG. 6 is a top perspective view of the completed and coated foundry tooling 400 illustrated with reference to FIG. 4, produced in accordance with some methods of the present disclosure. The particular configuration of the completed and coated foundry tooling 400 can be the same as that illustrated for the foundry tooling body 100 in FIGS. 1-2, FIG. 3A, and FIG. 3B, above. FIG. 6 can provide a complete view of the configuration details.

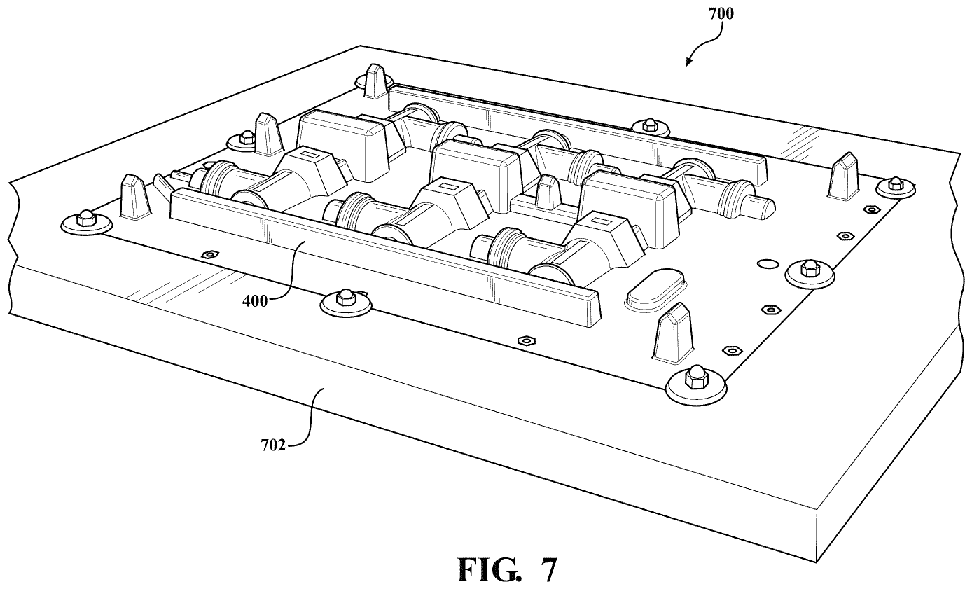

FIG. 7 is a perspective view of the completed foundry tooling 400 of FIG. 6 loaded into a molding machine 700 (FIG. 9, step 910), and in the example illustrated in FIG. 7, mounted onto a jig 702 of the molding machine 700. The molding machine 700 can be any suitable molding machine on which the foundry tooling 400 can be mounted, an example of which is a tooling machine commercially available from the DISA Group under the trademark DISA®, Model Number 20/24. The foundry tooling 400 can be mounted to the jig 702 by any suitable means, such as a plurality of fasteners extending through the apertures 104,106 (FIG. 6). In accordance with step 912 of FIG. 9, the jig 702 of the molding machine 700 can be moved in a direction that brings the foundry tooling 400 into contact with a malleable blank (not shown). In various aspects of the present disclosure, it can be understood that, even though FIG. 7 shows only a single foundry tooling element 400 loaded into the molding machine 700, two tooling elements can be installed in the molding machine 700 such that the malleable blank can be pressed on both sides with one tooling element pressing into each side. In various aspects, a plurality of foundry tooling elements 400 can be loaded into the molding machine 700 as would be understood by one of skill in the art. The malleable blank can be composed of a mixture of sand and resin to create an unbonded sand mixture. As discussed in the incorporated U.S. Pat. No. 11,458,532, for example and without limitation, the resin can be a phenolic-urethane resin. Such a composition can allow the malleable blank to change shape responsive to pressure exerted by the foundry tooling 400. In accordance with step 914 of FIG. 9, the jig 702 can be further urged toward the malleable blank by the molding machine 700 such that the foundry tooling 400 can exert pressure upon the malleable blank until the blank transforms into the sand mold 800 (FIG. 8). After a predetermined time, the mold machine 700 can move the jig 702 in a direction away from the sand mold 800 to separate the foundry tooling 400 from the sand mold 800. The sand mold 800 can then be removed from the mold machine 700. If desired, the foundry tooling 400 can also be removed from the molding machine 700.

FIG. 8 is a top perspective view of a sand mold 800 that can be produced by the foundry tooling 400 of FIG. 6. As stated in step 914 of FIG. 9, the sand mold 800 can define a configuration complementary to the configuration of the foundry tooling 400. For example, where the foundry tooling 400 can define ribs 108 (FIG. 6), the sand mold 800 can define channels 802 each having a depth equal to the height of the ribs 108. The configuration of the sand mold 800 can function as a negative for the configuration to be assumed by a completed casting produced with the sand mold 800. In particular, the configuration of the sand mold 800 can define at least one sand mold cavity, for example, the channels 802. Molten metal, such as cast iron, ductile iron, bronze, or brass can then be poured into each of the sand mold cavities of the sand mold 800 to produce a final metallic casting from the sand mold 800 (FIG. 9, step 916). Although cast iron, ductile iron, bronze, and brass have been recited here as examples of the molten metal, it is to be understood that the present disclosure is not limited in scope to those molten metal materials, and that other suitable molten metal materials can be utilized within the scope of the present disclosure.

In various aspects, coating as disclosed herein—specifically, electroplating and PVD coating—can allow foundries or other manufacturers to harness the power of 3-dimensional printing to produce foundry tooling. To create pattern tooling such as the foundry tooling bodies 100 using traditional fabrication methods, production times can exceed two to three months in various aspects. Production of core boxes using typical fabrication methods can exceed five to six months. By contrast, a pattern such as the foundry tooling bodies 100 produced using AM methods described herein—including FDM, DLP, and SLA, among others—can be created in a matter of hours. In various aspects, such a pattern can be produced in a single eight-hour production shift. Production of a core box can be completed in a matter of days. Upon completion of AM production, the various patterns (such as foundry tooling bodies 100) or core boxes can be coated with PVD, electroplated, or both. Upon curing of the coating, such patterns or core boxes can be utilized in manufacturing operations.

In various aspects, production of tooling such as patterns and core boxes using the methods described herein can provide a 50% or greater cost savings when compared to production of tooling using traditional methods. In various aspects, tooling produced using methods described herein can have similar performance and durability characteristics to tooling produced using traditional methods.

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A method of manufacturing foundry tooling, the method comprising the steps of:
forming a foundry tooling body in accordance with a predetermined model; and
coating the foundry tooling body using PVD to add a metallic coating to at least a portion of the foundry tooling body to define at least one coated tooling body surface, wherein each coated tooling body surface is configured to contact a malleable blank to produce a sand mold suitable for manufacturing a casting.

2. The method of claim 1, wherein the foundry tooling body is formed by additive manufacturing.

3. The method of claim 2, where the additive manufacturing process comprises at least one of FDM, DLP, and SLA.

4. The method of claim 1, wherein the foundry tooling body is formed of photocured resin.

5. The method of claim 1, wherein the foundry tooling is at least one of a pattern, a core box, and a cope and drag of a pattern.

6. The method of claim 1, wherein the metallic coating comprises at least one of titanium, zirconium, aluminum, chromium nitride, titanium nitride, zirconium nitride, aluminum titanium nitride, steel, copper, and gold.

7. The method of claim 1, wherein the metallic coating has a thickness from and including 0.001 inches to and including 0.002 inches.

8. The method of claim 1, wherein the metallic coating has a thickness from and including 0.001 inches to and including 0.004 inches.

9. The method of claim 1, wherein the metallic coating has a thickness of about 0.001 inches.

10. The method of claim 1, further comprising the step of washing the foundry tooling body after the step of forming the foundry tooling body.

11. The method of claim 10, further comprising the step of curing the foundry tooling body after the step of washing the foundry tooling body.

12. A method of manufacturing a casting, the method comprising the steps of:
manufacturing a foundry tooling body, the step of manufacturing the foundry tooling body comprising the steps of:
forming a foundry tooling body in accordance with a predetermined model; and
coating the foundry tooling body using PVD to add a metallic coating to at least a portion of the foundry tooling body to define at least one coated tooling body surface, wherein each coated tooling body surface is configured to contact a malleable blank to produce a sand mold suitable for manufacturing a casting,
wherein the foundry tooling body defines a first configuration;
loading the foundry tooling body into a molding machine;
using the molding machine to bring the foundry tooling body into contact with a malleable blank comprised of a mixture of sand and a resin; and
using the molding machine to further urge the foundry tooling body toward the malleable blank such that the foundry tooling exerts pressure upon the malleable blank until the malleable blank transforms into a sand mold, the sand mold defining a second configuration complementary to the first configuration, wherein the second configuration defines at least one sand mold cavity.

13. The method of claim 12, further comprising the step of pouring molten metal into the at least one sand mold cavity to produce a final casting from the sand mold.

14. The method of claim 13, wherein the molten metal comprises one of cast iron, ductile iron, bronze, and brass.

15. The method of claim 12, wherein the foundry tooling is at least one of a pattern, a core box, and a cope and drag of a pattern.

16. The method of claim 12, wherein the foundry tooling body is formed of photocured resin.

17. The method of claim 12, wherein the metallic coating has a thickness from and including 0.001 inches to and including 0.002 inches.

18. The method of claim 12, wherein the metallic coating has a thickness from and including 0.001 inches to and including 0.004 inches.

19. The method of claim 12, wherein the metallic coating has a thickness of about 0.001 inches.

20. The method of claim 12, wherein the metallic comprises at least one of titanium, zirconium, aluminum, chromium nitride, titanium nitride, zirconium nitride, aluminum titanium nitride, steel, copper, and gold
